(19) United States
(12) Patent Application Publication
(10) Pub. No.: US 2025/0388278 A1
(43) Pub. Date: Dec. 25, 2025

(54) DUAL ACTING HYDRAULIC SYSTEM AND RELATED DEVICES AND METHODS

(71) Applicant: Behnke Enterprises, Inc., Farley, IA (US)

(72) Inventor: Levi Behnke, Epworth, IA (US)

(21) Appl. No.: 19/225,126

(22) Filed: Jun. 2, 2025

Related U.S. Application Data
(60) Provisional application No. 63/654,568, filed on May 31, 2024.

(51) Int. Cl. B62D 63/06; F15B 1/26; F15B 13/02; F15B 13/06; F15B 15/06; F15B 21/00

(52) U.S. Cl. CPC B62D 63/061; F15B 1/26; F15B 13/024; F15B 13/027; F15B 13/06; F15B 15/06; F15B 21/005

(57) ABSTRACT

The disclosed system, and related devices and methods, relate to a configuration of fluid handling components that allow for actuation on command as well as damped reaction to sufficiently strong external forces. The system can have significant applications in tilting trailers, lift gates, lift tables, ramps, and similar hydraulic equipment.

### CROSS-REFERENCE TO RELATED APPLICATION(S)

This application claims priority under 35 U.S.C. § 119(e) to U.S. Provisional application Ser. No. 63/654,568, entitled “DUAL ACTING HYDRAULIC SYSTEM AND RELATED DEVICES AND METHODS,” filed May 31, 2024, which is hereby incorporated by reference in its entirety for all purposes.

### TECHNICAL FIELD

The disclosure relates to technologies useful in the field of hydraulics generally, and application of hydraulically powered equipment, specifically.

### BACKGROUND

As illustrated in FIGS. 1A and 1B, trailers 1 may use a tiltable deck 2 to allow for loading, driving, or rolling equipment onto the trailer 1 from ground level. These tiltable decks 2 typically reside in a flat position, where no part of the deck 2 is in contact or near contact with the ground, shown in FIG. 1A. Then, the tiltable decks 2 may often raise at the front of the trailer 1 and lower at the rear of the trailer 1 such that the deck 2, now in a tilted position, creates a ramp onto which items and equipment can be rolled or driven. This configuration is shown in FIG. 1B. In some instances, the shifting weight of the equipment on the trailer 1 may cause the deck 2 to tend to return to the non-tilted position, i.e. with the loading end of the trailer 1 no longer in contact with the ground. This shift of the deck 2 may be abrupt and forceful when the equipment being loaded is heavy, and especially if the deck 2 is locked into the tilted position and only released once the trailer 1 is fully loaded. This abrupt and forceful shift may cause damage to the trailer 1 and equipment and causes a safety risk for people near the trailer 1, who may have body parts near the shifting parts.

### BRIEF SUMMARY OF THE INVENTION

Described herein are various implementations relating to systems, devices, and methods for improving the functionality of hydraulic systems. The described systems, devices, and methods provide improved versatility, due to the fact that they bring together the ability to actuate on direct commands, as well as revert to baseline positions through external changes, along with other functions.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF DRAWINGS

FIG. 1A shows a trailer in the flat position, according to one implementation.

FIG. 1B shows a trailer in the tilted position, according to one implementation.

FIG. 2A is an isometric view of the manifold, according to one implementation.

FIG. 2B is an isometric view of the manifold, according to one implementation.

FIG. 3 is a diagram of the manifold, according to one implementation.

FIG. 4A is a diagram of the system, according to one implementation.

FIG. 4B is a diagram of the system operating to retract the hydraulic actuator, according to one implementation.

FIG. 4C is a diagram of the system operating to extend the hydraulic actuator, according to one implementation.

FIG. 4D is a diagram of the system retracting the hydraulic actuator under an external load, according to one implementation.

FIG. 4E is a diagram of the system extending the hydraulic actuator under an external load, according to one implementation.

FIG. 5 is a hydraulic diagram of the system, according to one implementation.

FIG. 6A is a front view of the manifold, according to one implementation.

FIG. 6B is a back view of the manifold, according to one implementation.

FIG. 6C is a top view of the manifold, according to one implementation.

FIG. 6D is a bottom view of the manifold, according to one implementation.

FIG. 6E is a side view of the manifold, according to one implementation.

FIG. 6F is a side view of the manifold, according to one implementation.

### DETAILED DESCRIPTION

Described herein is an improved dual acting hydraulic system and associated devices and methods. Various implementations of the system may be used in connection with trailers that have a tilt function, although many other applications are possible. A non-exhaustive list of such applications includes dock levelers, lift tables, forklifts, agricultural equipment such as tractors, excavation equipment, or any other similar application that may benefit from a dual action hydraulic system.

Throughout this disclosure, there are numerous references to fluid. As would be understood, this fluid may be any fluid that is materially compatible with the components of the system 12. A non-exhaustive list of potential fluids includes hydraulic fluid, mineral oil, plant or vegetable oil, power steering fluid, water, saline, air, nitrogen, and other situationally appropriate fluids and combinations thereof, including additives to increase heat stability, longevity, lubrication, and the like. The fluid may be compressible or incompressible.

As would also be known in the art, trailers may be difficult to shift to the tilted position. Many trailer decks 2 are large and heavy that require significant force to tilt them for equipment loading. Likewise, if insufficient weight is added to the trailer 1 to shift the weight forward and cause its natural return from the tilted position, an active method of returning the deck 2 to its flat position will be needed. This disclosure provides a solution to these problems as well as others.

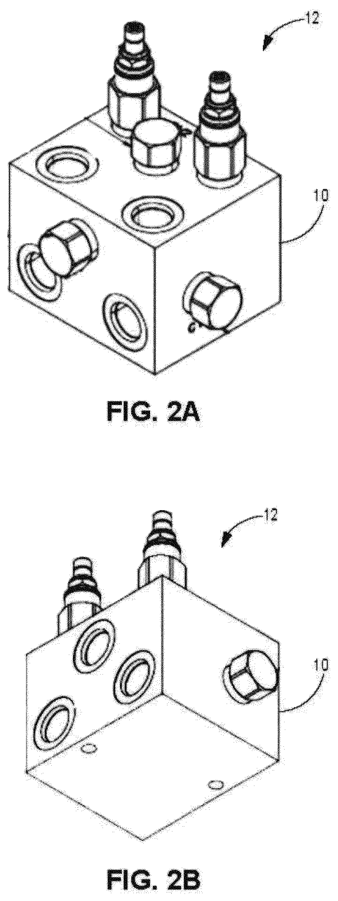

FIGS. 2A and 2B show an implementation of a manifold 10 used within the system 12. In various implementations, the manifold 10 is used in a system 12 that also uses a hydraulic pump assembly (not shown) and one or more hydraulic actuators (not shown). In various implementations, the manifold 10 may be a solid body with several connected components within.

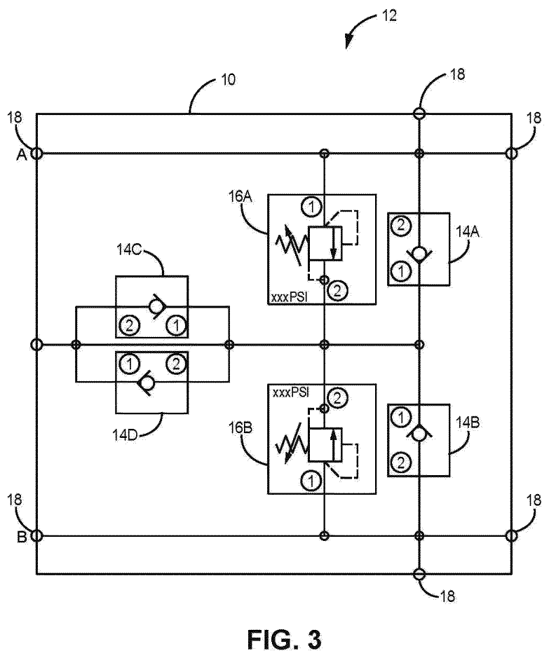

FIG. 3 shows a diagram of the internal components of the manifold 10, according to various implementations. In some implementations, the manifold 10 may have a check valve 14 or a plurality of check valves 14A, 14B, 14C, 14D and one or more relief valves 16A, 16B. In various implementations, the check valves 14A, 14B, 14C, 14D are constructed to allow fluid to pass in one direction with relatively low resistance, but to disallow the flow of fluid in the other direction. Various styles of check valves may be used, such as but not limited to poppet check valves, ball check valves, swinging check valves, diaphragm check valves, butterfly check valves, stop check valves, lift check valves, duckbill valves, reed valves, or any other style of check valves considered equivalent in the art.

The relief valves 16A, 16B, in some implementations, are constructed to disallow fluid flow in one direction until a sufficient pressure is applied to the relief valves 16A, 16B and to disallow fluid flow entirely in the other direction. The pressure sufficient to allow fluid flow in one direction is referred to as the setpoint or setpoint pressure. Various styles of relief valves 16A, 16B may be used, such as but not limited to conventional spring-loaded relief valves, balanced spring-loaded relief valves, pilot operated relief valves, power actuated relief valves, temperature pressure actuated relief valves, or any other style of relief valves considered equivalent in the art.

In various implementations, the setpoint of the relief valves 16A, 16B may be adjustable. In other implementations, the setpoint of the relief valves 16A, 16B may be fixed. In various implementations, the setpoint of the relief valves 16A, 16B may be in the range of about 1 psi to about 1,000 psi. In further implementations, the setpoint of the relief valves 16A, 16B may be in the range of about 50 psi to about 800 psi.

As would be understood, the setpoint, in various implementations, can be changed and tuned correspond to a desired weight or force, at which the hydraulic actuator 22 can yield to the force. For example, in one implementation where the system 12 is used for a trailer 1 designed to carry a vehicle of a certain weight, the setpoint may be adjusted so the relief valves 16A, 16B open when the vehicle is driven onto the deck 2. The desired weight or force at which the hydraulic actuators 22 will yield may be called the yield force. As would be understood, the specific setpoint corresponding to the desired yield force will vary from implementation to implementation based on changes in the system 12 sizing. In some implementations, the setpoint of the relief valves 16A, 16B may be fixed at a certain pressure that corresponds to a particular vehicle with a particular weight, such as a vehicle for which the trailer is designed to be compatible with.

In some implementations, the check valves 14 are in fluidic communication with one another, with the relief valves 16A, 16B, and with several ports 18. In various implementations, the ports 18 may be constructed to allow for the coupling of the manifold 10 and its components to pipes, hoses, or other fluid transfer devices. In some implementations, the ports 18 may be threaded, such as SAE hydraulic thread. In further implementations, the ports 18 may use other connection technologies, such as high-pressure clamp couplers, quick-disconnect couplers, or similar couplers known to the art. In still further implementations, the fluid transfer devices coupling to the ports 18 may be welded, brazed, soldered, or otherwise permanently affixed to the ports 18. Of course, any combination of these and other technologies may be used on the same implementation.

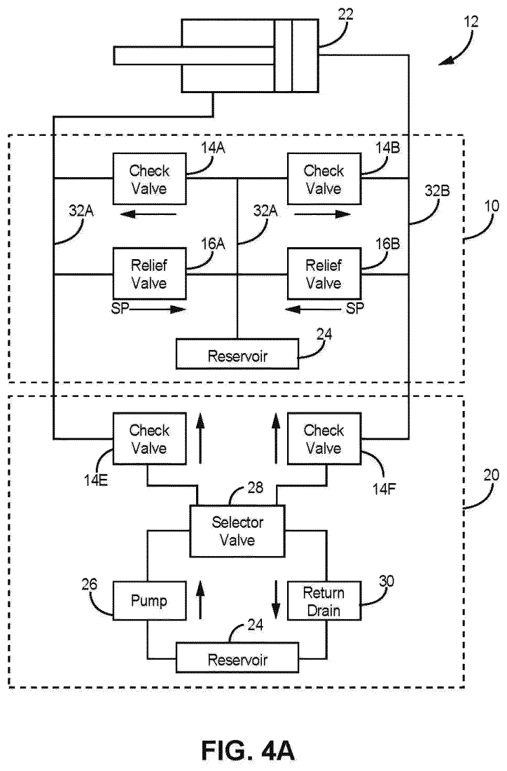

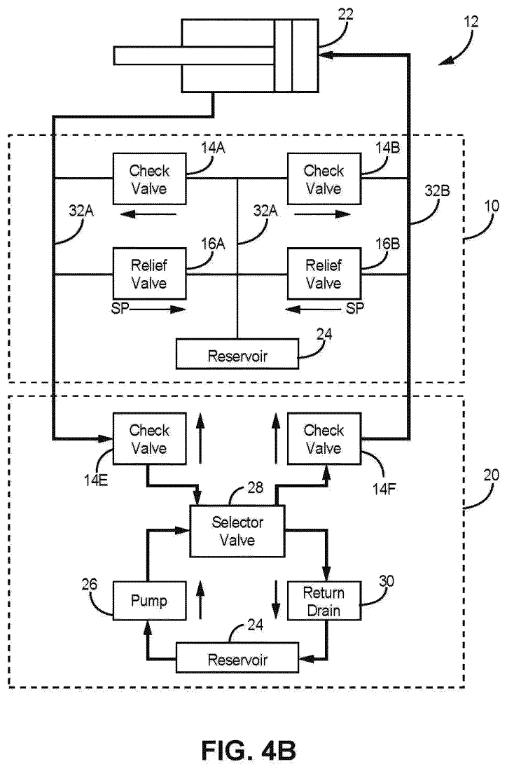

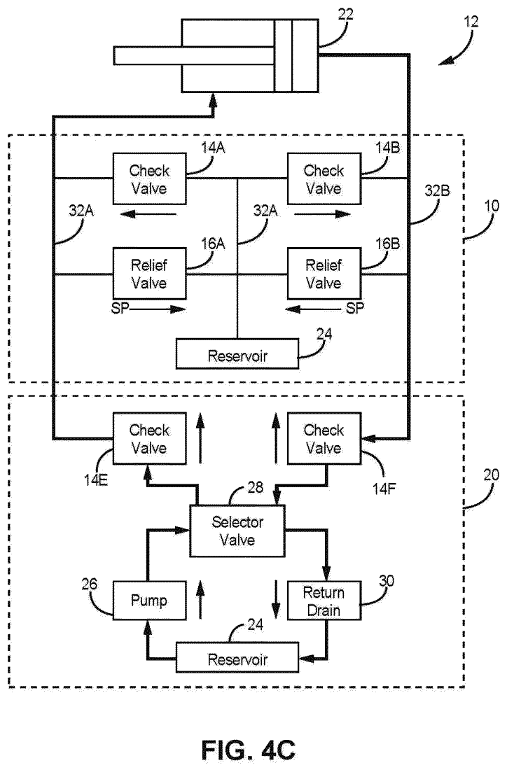

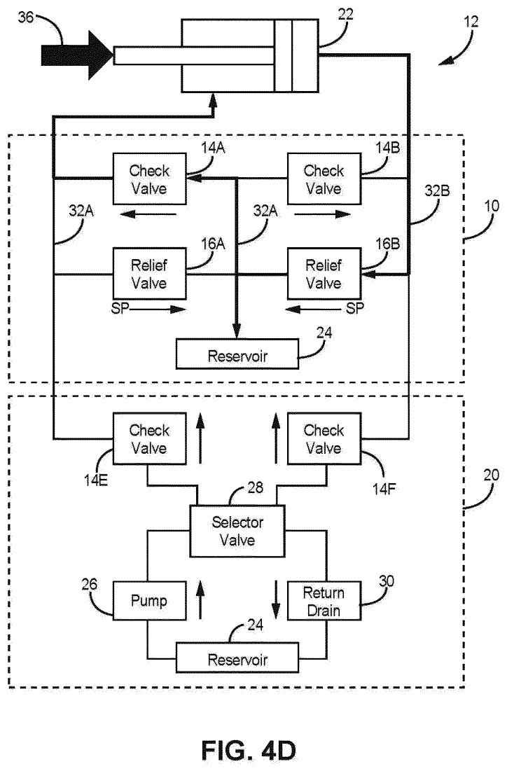

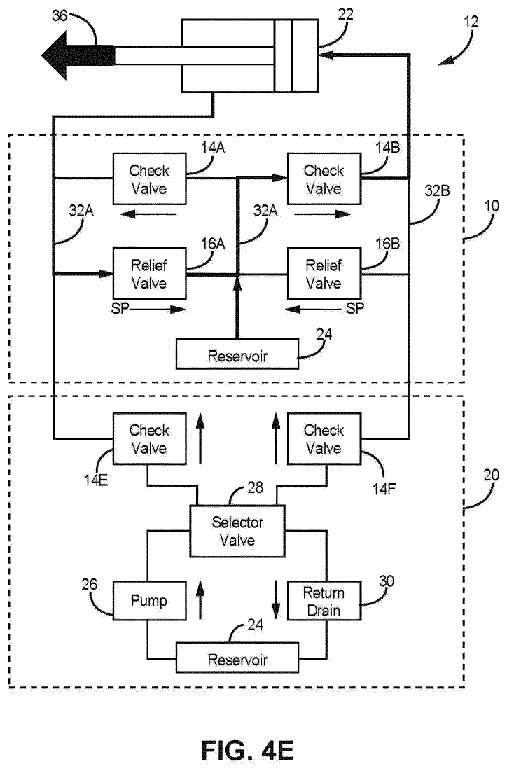

Turning now to FIG. 4A, the manifold 10 may be in fluidic communication with both a hydraulic pump assembly 20 and one or more hydraulic actuators 22. In some implementations, the hydraulic pump assembly 20 may include a reservoir 24 constructed to hold a fluid, which is in fluidic communication with a pump 26 constructed to pressurize and move a fluid. The pump 26, may be in fluidic communication with a selector valve 28, so that the pump 26 is capable of drawing fluid from the reservoir and pushing it toward the selector valve 28. In various implementations, the selector valve 28 may be a 4-way, 2-position valve with two inlets and two outlets. As would be understood, this style of valve may invert which outlet leads to which inlet. The selector valve 28 may also be a solenoid valve, optionally with a spring return, although other styles of valve are possible. The selector valve 28, in some implementations, may be in fluidic communication with the reservoir 24 through a return drain 30.

The outlets of the selector valve 28, in some implementations, are connected to check valves 14E, 14F that allow fluid to flow out of the hydraulic pump assembly 20, but do not allow fluid to flow in. In some implementations, the check valves 14E, 14F may be constructed in different styles. In one implementation, one check valve 14E may be a 2-way, 2-position solenoid valve, and the other check valve 14F may be a check valve of various construction, as discussed above. In various implementations, the check valves 14E, 14F in the hydraulic pump assembly 20 may be constructed to open to allow flow in both directions upon receiving inputs to do so. In some implementations, the check valves 14E, 14F are opened to allow all flow when the pump 26 is engaged and pumping fluid.

In some implementations, the check valves 14E, 14F may in fluidic communication with the manifold 10 and its components, namely, the check valves 14A, 14B and relief valves 16A, 16B. In some implementations, the manifold 10 check valve 14A, relief valve 16A, and hydraulic pump assembly 20 check valve 14E are in fluidic communication due to a mutual connection by a lowering hose array 32A. In various implementations, the lowering hose array 32A is connected to the hydraulic actuator 22 such that fluid in the lowering hose array 32A will enter the chamber of the hydraulic actuator 22 designed to retract the hydraulic actuator 22.

In some implementations, the manifold 10 check valve 14B, relief valve 16B, and hydraulic pump assembly 20 check valve 14F are in fluidic communication due to a mutual connection by a raising hose array 32B. In some implementations, the lowering hose array 32A and raising hose array 32B may be branched fluid conduits, such as hydraulic hoses, piping, or similar materials capable of allowing the contained transfer of fluid. In various implementations, the raising hose array 32B is connected to the hydraulic actuator 22 such that fluid in the raising hose array 32B will enter the chamber of the hydraulic actuator 22 designed to extend the hydraulic actuator 22.

In various implementations, the manifold 10 check valves 14A, 14B are in fluidic communication with each other and with the relief valves 16A, 16B due to a mutual connection by an internal array 34. In some implementations, the internal array 34 may be made of branching hoses, such as hydraulic hoses, piping, or similar materials capable of allowing the contained transfer of fluid. In various implementations, the internal array 34 may also being in fluidic communication with a reservoir 24 constructed to hold a fluid. In some implementations, the reservoir 24 in fluidic communication with the internal array 34 may be the same as the reservoir 24 drawn on by the pump 26. In other implementations, two separate reservoirs 24 may be used: one for the internal array 34 and one for the pump 26. In still further implementations, other configurations are possible.

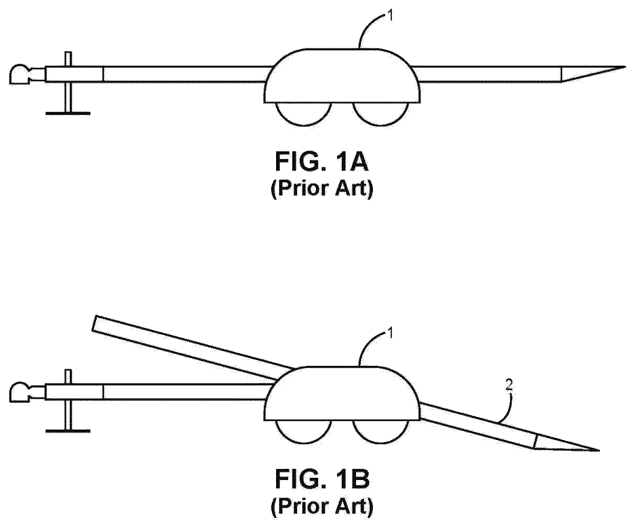

FIG. 4B shows the system 12 being used to extend a hydraulic actuator 22, according to some implementations. In various implementations, the trailer deck 2 may be in a flat position when the hydraulic actuator 22 is retracted, as shown in FIG. 1A. Likewise, the hydraulic actuator 22 may be attached to a trailer 1 such that when the hydraulic actuator 22 is extended, the trailer deck 2 is in a tilted position, as is shown in FIG. 1B.

Returning to FIG. 4B, in some implementations, fluid may be drawn from the reservoir 24 by the pump 26 and pumped through the selector valve 28, which directs the fluid through a check valve 14F into the raising hose array 32B and into the hydraulic actuator 22. As discussed above, fluid entering the hydraulic actuator 22 from the raising hose array 32B will tend to cause the hydraulic actuator 22 to extend, as fluid pressure from the pump 26 exerts force on the hydraulic actuator 22 piston.

In some implementations, as the piston of the hydraulic actuator 22 moves toward the extended position, fluid is pressed out of the hydraulic actuator 22 and into the raising hose array 32B. From there, the fluid may pass through the check valve 14E that may be opened to allow fluid flow in both directions, as discussed above. In some implementations, the fluid is then directed by the selector valve 28 through the return drain 30 back to the reservoir 24. In various implementations, this action is referred to as the “power up” action.

Turning to FIG. 4C, in some implementations, fluid may be drawn from the reservoir 24 by the pump 26 and pumped through the selector valve 28, which directs the fluid through a check valve 14E into the lowering hose array 32A and into the hydraulic actuator 22. As discussed above, fluid entering the hydraulic actuator 22 from the lowering hose array 32B will tend to cause the hydraulic actuator 22 to retract, as fluid pressure from the pump 26 exerts force on the hydraulic actuator 22 piston.

In some implementations, as the piston of the hydraulic actuator 22 moves toward the retracted position, fluid is pressed out of the hydraulic actuator 22 and into the raising hose array 32B. From there, the fluid may pass through the check valve 14F that may be opened to allow fluid flow in both directions, as discussed above. In some implementations, the fluid is then directed by the selector valve 28 through the return drain 30 back to the reservoir 24. In various implementations, this action is referred to as the “power down” action.

Turning to FIG. 4D, in some implementations, an external load 36 may be introduced onto the hydraulic actuator 22. In the implementation of FIG. 4D, this external load 36 is compressing the hydraulic actuator 22. In some implementations, the external load 36 may result from a large piece of equipment, such as a vehicle, being placed upon a trailer deck 2 that is mated to the hydraulic actuator 22. In some implementations, the external load 36 may tend to exert a force on the shaft and piston of the hydraulic actuator 22 in the direction of the retracted position. This exerted force may then be transferred into the fluid within the raising hose array 32B. In various implementations, the check valves 14B, 14F in fluidic communication with the raising hose array 32B prevent the flow of the fluid out of the raising hose array 32B. As would be understood, retaining the fluid in the raising hose array 32B at a substantially fixed volume while exerting a force onto the fluid from the external load 36 will cause the pressure of the fluid to increase. In various implementations, a sufficiently heavy external load 36 will cause the resulting fluid pressure to exceed the setpoint pressure of the relief valve 16B. Once the fluid pressure exceeds the setpoint of the relief valve 16B, the relief valve 16B may open to allow fluid flow through it. The fluid may then flow into the internal array 34.

Fluid in the internal array 34, in some implementations, may then flow through the check valve 14A into the lowering hose array 32A and into a chamber of the hydraulic actuator 22. As would be understood, as fluid is pushed by the piston of the hydraulic actuator 22 through the manifold 10 and back into the opposite chamber of the hydraulic actuator 22, the piston will move toward the retracted position. In various implementations, this action is referred to as “gravity down”. In various implementations, the speed of this gravity down movement can be determined by the sizing of various components in the manifold and by the addition of flow restrictions. In some implementations, the check valves 14 may function as flow restrictions when allowing fluid to flow through.

In various implementations, the manifold 10 may also direct fluid flow through the alternate relief valve 16A and check valve 14B in a gravity down scenario. As would be understood, the optional redundancy of these components allows for flexibility in installing the manifold 10 into various systems 12, where gravity down scenarios may alternate in direction or fluid flow.

In some implementations, the volume of fluid displaced from one chamber of the hydraulic actuator 22 does not equal the volume drawn into the opposite chamber due to the presence of the actuator shaft and other factors. In some implementations, during a gravity down action, fluid may be added or drawn from the reservoir 24 in fluidic communication with the internal array 34 as needed. In implementations where the external load 36 is compressing the hydraulic actuator 22, fluid may tend to fill the reservoir 24.

In some implementations, such as in FIG. 4E, the external load 36 may pull the shaft of the hydraulic actuator 22. This may occur in many implementations, but a common situation that would result in the pulling action is when equipment is positioned so that the fulcrum of a tiltable deck 2 of a trailer 1 is between the equipment and the hydraulic actuator 22. As would be understood, the fulcrum may be any hinging apparatus that allows the deck 2 to pivot in relation to the trailer 1 while remaining fixed relative to the trailer 1 in other dimensions. This may occur when a vehicle on the trailer 1 is backed up to the rear end of the trailer 1. As would be understood, the tilt deck 2 of the trailer 1 would then experience a moment of inertia about the fulcrum, which would result in a force tending to extend the hydraulic actuator 22.

In implementations similar to this, fluid may tend to be pushed from one chamber of the hydraulic actuator 22 into the lowering hose array 32A. Similar to above, if the fluid is pushed into the lowering hose array 32A with sufficient force, the fluid pressure may rise to match or exceed the setpoint of the relief valve 16A in fluidic communication with the lowering hose array 32A. In some implementations, the fluid pressure reaching the setpoint may cause the relief valve 16A to open, where the fluid may then enter the internal array 34. In various implementations, the fluid may then pass through the check valve 14B into the raising hose array 32B and then into the other chamber of the hydraulic actuator 22.

Similar to above, in some implementations, the volume of fluid displaced from one chamber of the hydraulic actuator 22 does not equal the volume drawn into the opposite chamber due to the presence of the actuator shaft and other factors. In some implementations, during a gravity down action, fluid may be added or drawn from the reservoir 24 in fluidic communication with the internal array 34 as needed. In implementations where the external load 36 is extending the hydraulic actuator 22, fluid may tend to drain the reservoir 24.

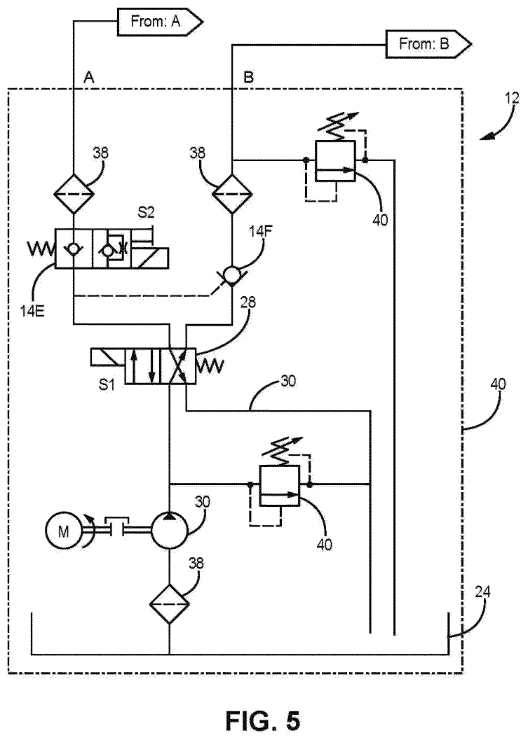

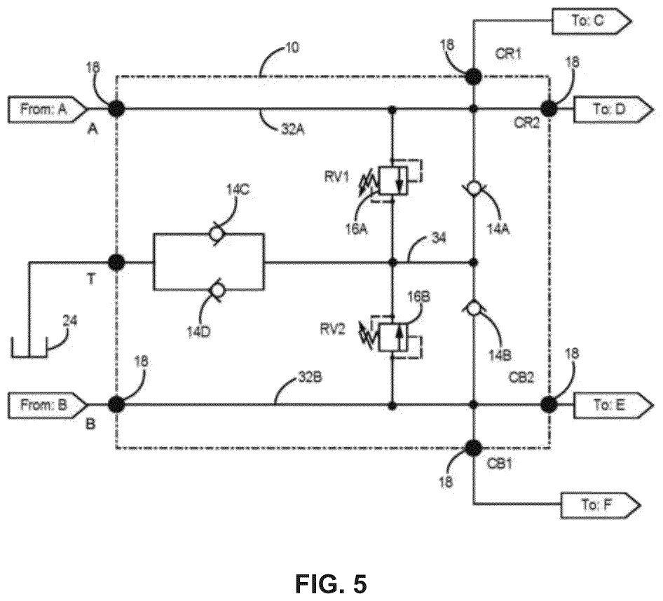

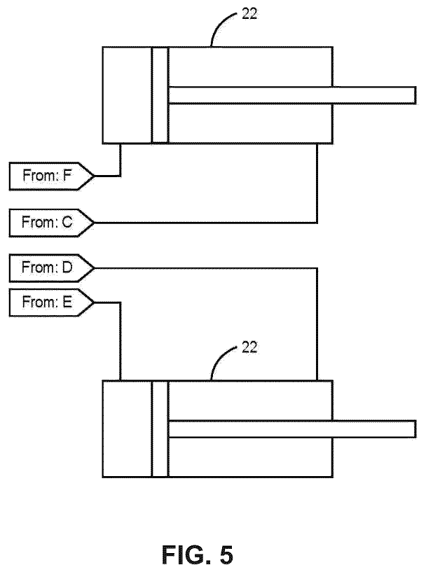

FIG. 5 shows a hydraulic diagram of the system 12 as seen in some implementations. The implementations of FIG. 5 include additional devices that improve safety and efficiency of the system 12. In the implementation of FIG. 5, two hydraulic actuators 22 are in the system 12. However, any number of hydraulic actuators could be used within the system 12.

In some implementations, filters 38 may be placed in the system 12, such as in the hydraulic pump assembly 20, to remove contaminants from the fluid.

In some implementations, pressure safety valves 40 or PRVs 40 may also be installed in the system 12 to ensure pipes and hoses are not over pressurized. The PRVs 40 may be constructed to disallow fluid flow through themselves until a setpoint pressure is reached, at which point, the PRVs 40 may open to allow fluid flow, which decreases or maintains the fluid pressure.

As would be understood, the PRVs 40 may function in similar manner to the relief valves 16A, 16B of the system 12, but are intended to only open in abnormal situations and are not intended to open as part of routine operation. Due to this, in some implementations, the PRVs 40 may be different in construction and operation than the relief valves 16A, 16B. In various implementations, the PRVs 40 may be constructed to direct fluid passing through them to the reservoir 24.

In various implementations, the setpoint of the PRVs 40 may be adjustable. In other implementations, the setpoint of the PRVs 40 may be fixed. In various implementations, the setpoint of the PRVs 40 may be in the range of about 1 psi to about 10,000 psi. In further implementations, the setpoint of the PRVs 40 may be in the range of about 800 psi to about 3,000 psi.

Still in FIG. 5, in various implementations, the check valves 14C, 14D allowing fluid to enter and exit the manifold 10 may resist fluid flow until a setpoint pressure is reached. In some implementations, the check valve 14C allowing fluid to exit the manifold 10 may be constructed to allow fluid flow at a pressure higher than the check valve 14D allowing fluid to enter the manifold 10. In one specific implementation, the check valve 14C allowing fluid to exit the manifold 10 may be constructed to allow fluid flow at a pressure of 75 psi, and the check valve 14D allowing fluid to enter the manifold 10 may be constructed to allow fluid flow at a pressure of 1 psi. As would be understood, in this specific implementation, the increased resistance in retaining fluid in the manifold 10 will keep the manifold free of air pockets and ensure smooth operation.

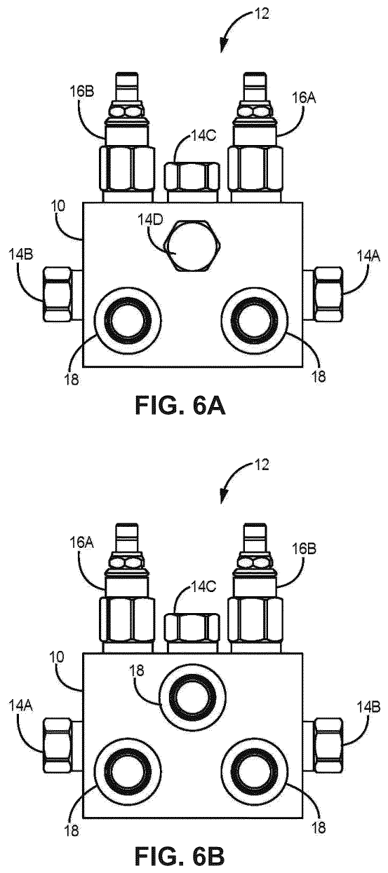

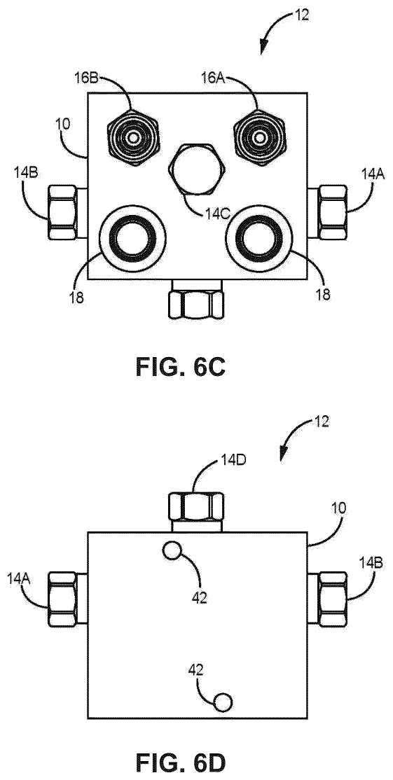

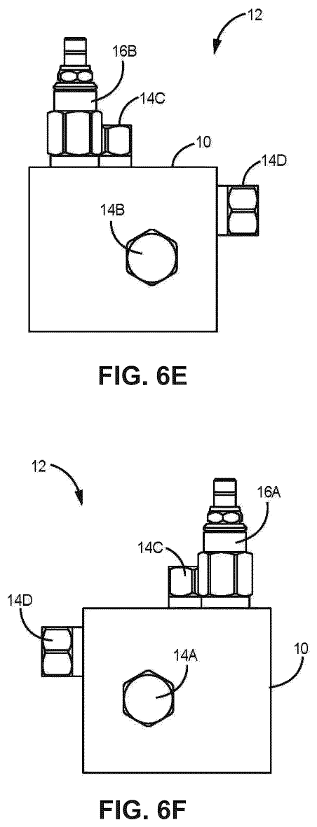

FIG. 6A, 6B, 6C, 6D, 6E, and 6F show the manifold 10, according to some implementations, from varying viewpoints. FIG. 6D shows an implementation where the manifold has mounting holes 42 that would allow the manifold to be secured, such as to a trailer 1. The mounting holes 42 may be threaded holes, keyhole mounts, or any other mounting technique known in the art.

Although the disclosure has been described with reference to preferred embodiments, persons skilled in the art will recognize that changes may be made in form and detail without departing from the spirit and scope of the disclosed apparatus, systems and methods.

What is claimed is:

1. A hydraulic system comprising:
(a) a hydraulic pump assembly;
(b) a manifold in fluidic communication with the hydraulic pump assembly; and
(c) one or more hydraulic actuators in fluidic communication with the manifold,
wherein the hydraulic pump assembly is configured to pump a fluid to the one or more hydraulic actuators to actuate them, and wherein the manifold is configured to relieve pressure in the fluid if the fluid pressure is above a setpoint.

2. The hydraulic system of claim 1, wherein the hydraulic pump assembly comprises:
(i) a reservoir;
(ii) a pump configured to draw fluid from the reservoir; and
(iii) a selector valve, in fluidic communication with the pump, capable of diverting fluid between two or more paths.

3. The hydraulic system of claim 2, wherein the hydraulic pump assembly further comprises:
(iv) a return drain configured to allow fluid to flow from the selector valve to the reservoir; and
(v) one or more check valves in fluidic communication with the selector valve, configured to disallow fluid to flow into the hydraulic pump assembly.

4. The hydraulic system of claim 1, wherein the setpoint is adjustable.

5. The hydraulic system of claim 4, wherein the setpoint is adjustable in the range of about 50 psi to about 800 psi.

6. The hydraulic system of claim 1, wherein the setpoint is fixed.

7. A hydraulic manifold comprising:
(a) one or more hose arrays fluidically connecting one or more ports; and
(b) one or more relief valves in fluidic communication with the one or more hose arrays,
wherein the one or more relief valves are configured allow a fluid to flow from one of the one or more hose arrays into another of the one or more hose arrays when the fluid pressure is at or above a setpoint.

8. The hydraulic manifold of claim 7, further comprising:
(c) one or more check valves in fluidic communication with the one or more hose arrays;
(d) a reservoir in fluidic communication with the one or more hose arrays; and
(e) at least one internal hose array in fluidic communication with the one or more check valves, the one or more relief valves, and the reservoir.

9. The hydraulic manifold of claim 8, wherein there are two relief valves, two hose arrays, and four check valves.

10. The hydraulic manifold of claim 8, wherein two of the four check valves are configured to allow fluid to pass between the internal hose array and the reservoir.

11. The hydraulic manifold of claim 8, wherein two of the four check valves are configured to allow fluid in the internal hose array to flow into one or two of the two hose arrays.

12. The hydraulic manifold of claim 7, wherein the setpoint is adjustable.

13. The hydraulic manifold of claim 12, wherein the setpoint is adjustable in the range of about 50 psi to about 800 psi.

14. The hydraulic manifold of claim 7, wherein the setpoint is fixed.

15. A tiltable trailer comprising:
(a) a tiltable deck configured to rotate about a fulcrum;
(b) one or more hydraulic actuators in operative communication with the tiltable deck;
(c) a hydraulic manifold in fluidic communication with the one or more hydraulic actuators; and
(d) a hydraulic pump assembly in fluidic communication with the hydraulic manifold,
wherein hydraulic manifold is configured to allow the hydraulic actuators to yield to a force corresponding to a yield force.

16. The tiltable trailer of claim 15, wherein the hydraulic manifold comprises one or more relief valves configured to allow the one or more hydraulic actuators to yield by allowing fluid to flow through the hydraulic manifold once the fluid reaches a setpoint pressure.

17. The tiltable trailer of claim 16, wherein the yield force may be adjusted by adjusting the setpoint pressure.

18. The tiltable trailer of claim 17, wherein the setpoint is adjustable in the range of about 50 psi to about 800 psi.

19. The tiltable trailer of claim 16, wherein the setpoint is fixed.

20. The tiltable trailer of claim 16, wherein the setpoint is fixed at a value in the range of about 50 psi to about 800 psi.
